(19) United States
(12) Patent Application Publication
(10) Pub. No.: US 2003/0118427 A1
(43) Pub. Date: Jun. 26, 2003

(54) Roll-changing apparatus

(76) Inventors: Markku Kojo, Espoo (FI); Aaron Mannio, Jarvenpaa (FI); Markku Kirvesmaki, Jarvenpaa (FI); Hannu Pullinen, Riihimaki (FI)

Correspondence Address: LATHROP & CLARK LLP, 740 REGENT STREET SUITE 400, P.O. BOX 1507, MADISON, WI, 537011507

(21) Appl. No.: 10/181,119

(22) PCT Filed: Jan. 19, 2001
(86) PCT No.: PCT/FI01/00045

(51) Int. Cl. B65G 1/04

(52) U.S. Cl. 414/282

(57) ABSTRACT

Roll-changing apparatus for a multi-nip calender an upright part (10) of the roll-changing apparatus having at least one vertical column (11), to which at least one horizontal beam (12) and, at its lower end, a carrier part (13) belong, and a roll-changing apparatus (1) of the roll changing apparatus further including a vertically moveable lifting carriage (14) which is fitted to the vertical column. According to the invention for transporting the rolls (21,22) of the calender (2) in the lateral direction from the calender to the roll store (3) and vice versa, the roll-changing apparatus (1) can be conveyed between calender and roll store, while the lifting carriage (14) of the roll-changing apparatus (1) is immovable in the lateral direction with respect to the vertical column (11).

The suject of the present invention is a roll-changing apparatus, defined in the precharacterizing clause of claim 1, for a multi-nip calender such as a super calender.

Changing rolls in the roll system of multi-nip calenders, in which a number of rolls are located one above another, as in the case of super cal enders, takes a very great deal of time because of the maintenance, inspection and/or repair requirement, since it is necessary to cool down or heat and remove or replace the roll to be changed if the roll is still in its mountings, such as in upright frames, and the additional equipment present on the roll, such as lead-in or lead-out roll, doctor, steam box and so on are still fixed to the roll, and because the roll store is provided to accommodate only single rolls. An apparatus for interchanging resilient rolls in a super calender is explained in the Finnish laid-open specification 90102, in accordance with which the apparatus includes a vertically moveable lifting platform and a conveying device for the lateral transport of resilient rolls between multi-nip calender and roll store and for the installation and removal of the lead-in or lead-out rolls, the conveying device having carriers which are firmly supported on the lifting platform and can be moved in the horizontal plane with respect to the latter in order to support the rolls.

From the prior art, mention should also be made of the fact that DE-C 43 13 475 presents a dimensioning solution which improves safety for the maintenance platform of the roll system of a super calender, it being possible for this solution to be used for the safer carrying out of inspection work and for relatively small maintenance work on the roll system. However, the solution according to the abovementioned specification cannot be used as a roll-changing apparatus.

At the present time, a roll to be changed is therefore separated from the additional equipment associated with it when the roll is still located in its holder in the upright frame, and is then brought out of the upright frame onto lifting sleeves, after which the roll is transported by a conveying apparatus into the roll store and a new roll is moved into its place, to which new roll the additional equipment belonging to the roll is fixed. This roll change on average takes up five hours.

A primary task of the present invention is to provide a new roll-changing apparatus with which the roll change can be accelerated significantly.

This object is achieved, by a roll-changing apparatus mentioned at the beginning whose primary characteristic features are defined in the characterizing clause of the appended claim 1.

The invention is based on the novel and ingenious idea that the roll and the additional equipment connected to it, such as lead-in or lead-out roll, doctor, steam box and so on, is removed as an entire assembly from the upright frame onto a lifting carriage and, together with the lifting carriage, is moved into the roll store as an assembly, from where, with the lifting carriage, a new roll including the equipment is introduced as an assembly and is fixed into the upright frame.

According to a preferred embodiment of the invention, there is in the lifting carriage for moving the roll assembly a conveying means which can be moved laterally in the horizontal plane, such as a conveying platform or a similar conveying support, onto which the roll assembly can be removed from the upright frame, and which can be moved laterally together with the lifting carriage, and which can be moved down by the lifting carriage onto carriers in the roll store.

It has been discovered that if a support such as a lifting carriage according to the invention is provided underneath the roll to be changed, the removal of the roll to be changed and of the associated additional equipment as an assembly can be carried out. This can preferably be carried out by the bearing block belonging to the roll to be changed and fixed to the upright frame being released from its fixing, with which the roll to be changed, whose bearing block is connected via a supporting carrier to the bearing block of the lead-in or lead-out roll, including its associated additional parts, can be removed as a complete roll assembly onto the lifting carriage, which is designed to accommodate the roll assembly formed by the roll and guide roll, after which the roll assembly can be transported by the lifting carriage into the roll store, which is equipped with conveying means to accommodate and to move the roll assembly in the horizontal plane, in such a way that the roll assembly taken onto the roll carriage from one direction can be conveyed in the horizontal direction and horizontal plane to the other edge of the lifting carriage, in order to be conveyed into the roll store and vice versa.

Among the advantages of the invention, mention is to be made of the fact that the roll-changing time is shortened to about one fifth of the current duration, as compared with current changing technique, that it is not necessary at all to wait for the rolls to cool down, since all the movements can be managed during the replacement, for which reasons the machine downtime is shortened and minimized. Further advantages consist in the fact that reliance on the overhead crane is reduced, the maintenance frame can be constructed in a manner suitable for all process rolls, and that, by using the roll-changing solution according to the invention, the movement of the lifting carriage in the lateral direction can be implemented completely, the construction of the lifting carriage being simple.

In the following text, the invention will be explained in detail with reference to the appended drawing, in the

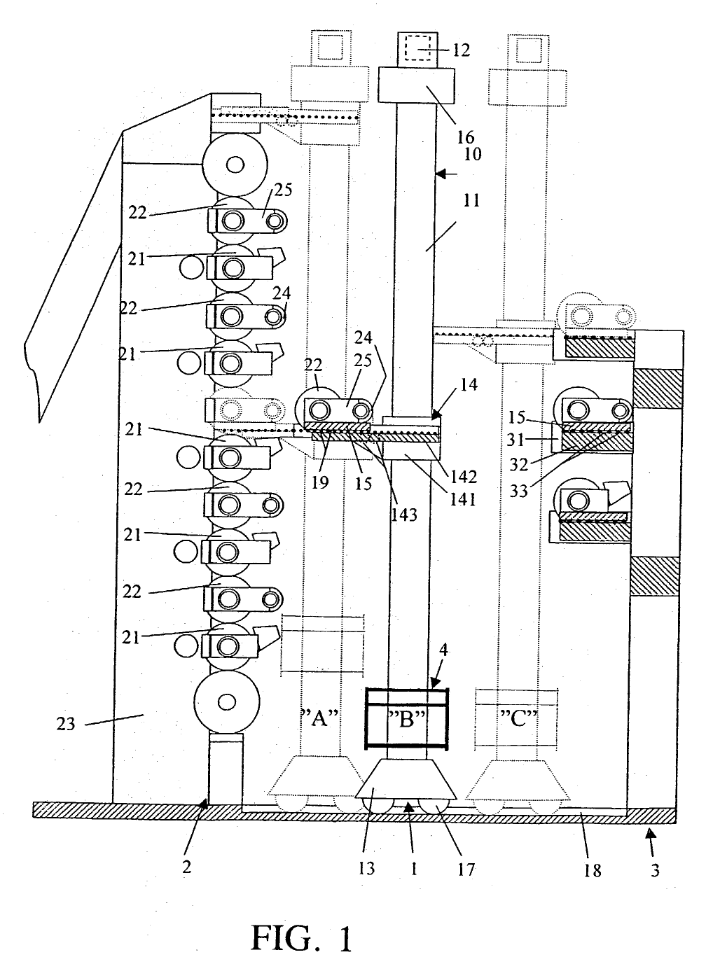

FIG. 1 of which a preferred embodiment of the roll-changing apparatus according to the invention is illustrated schematically.

The roll-changing apparatus 1 shown in the FIG. 1 is provided for changing rolls 21,22 of the roll system of a multi-nip calender, preferably for changing rolls 22 belonging to the roll system and provided with resilient surfaces. The intermediate rolls are alternately thermal rolls with a chill-cast surface and polymer or paper rolls with a resilient surface. For the purpose of treating the paper web on both sides in the multi-nip calender, a so-called reversible nip is provided, in which two rolls with a resilient surface are located opposite each other.

The roll-changing apparatus 1 according to the invention includes, as upright part, a portal upright 10, which has vertical columns 11, a horizontal intermediate beam 12 connecting the vertical columns and a carrier part 13, that is to say an end carrier, provided at the lower end of both vertical columns 11. As can further be seen from the FIG. 1, fitted between the vertical columns 11 is a lifting carriage 14, which includes sleeve-like side carriers 141 moving along on the vertical columns and a rack part 142 fixed between the side carriers, the said lifting carriage 14 moving vertically between the vertical columns. For the purpose of moving the lifting carriage 14 vertically, the roll-changing apparatus 1 according to the invention is equipped with a lifting drive 16, which is fitted to the upper part of the vertical columns 11.

In order to transport the rolls to be changed from the multi-nip calender 2 into a roll store 3 and vice versa, the roll-changing apparatus according to the invention can be transported in the lateral direction, that is to say between multi-nip calender 2 and roll store 3, for which purpose both end carriers 13 of the portal stand 11 are equipped with conveying elements 17, which are preferably formed by wheels mounted on the end carriers and moving/rolling on guide means 18 which are present in the floor of the machine hall and are preferably formed by rails.

According to the invention, the roll 22 to be changed and the additional equipment belonging to it, such as lead-in and lead-out roll, doctor, steam box and so on, is removed as an entire roll assembly from the upright frame 23 of the multi-nip calender 2 onto the lifting carriage 14, and moved by the lifting carriage 14 as a complete assembly into the roll store 3, from where, using the lifting carriage 14, a new roll assembly is moved as a complete roll assembly, and is fixed to the upright frame 23 of the multi-nip calender 2. According to the invention, this is carried out by the bearing block belonging to the roll 22 to be changed and fixed to the upright frame being detached from its fixing in the upright part 23 of the calender, the roll 23 to be changed, to whose bearing block a bearing block of the lead-in and/or lead-out roll 24 belongs via a supporting or intermediate carrier 25, inclusive of the associated additional parts, is removed as a complete roll assembly on the lifting carriage, which is designed to accommodate the roll 22 and the complete roll assembly including the guide roll 24, after which the roll assembly can be conveyed into the roll store 3 by the lifting carriage 14, which is equipped with a conveying means 19 to accommodate and to transport the roll assembly in the horizontal direction, in such a way that the roll assembly, taken onto the lifting carriage 14 from one direction, can be conveyed in the horizontal direction and plane to the other edge of the lifting carriage 14 for the purpose of being conveyed into the roll store 3, and vice versa.

According to the invention, the lifting carriage 14 which can move vertically on the vertical columns 11 is of compact construction. In order to permit the movement of the roll assembly from the multi-nip calender 2 or the roll store 3 onto the lifting carriage 14 from one edge to the other of the latter, the lifting carriage 14 includes a conveying means 15 for the roll assembly which can be moved in the horizontal direction on the lifting carriage and which, according to the invention, preferably comprises a moveable conveying platform or similar conveying support. If the conveying means 15 comprises a conveying platform or similar conveying support, the mobility in the horizontal plane can be designed, for example, with load-bearing rollers or rolls 19 which are illustrated in the FIGURE and which are mounted on the side-carrier parts 141 and/or the rack part 142 of the lifting carriage 14. Of course, the movement of the conveying means 15 can also be executed with a different solution known per se, such as by using a flexible chain or belt drive or, for example, by the mating faces of the conveying means 15 and of the rack part 14 being designed to slide in relation to each other. According to the invention, the roll assembly is easy to move with the laterally moveable conveying means 15 of the lifting carriage 14, which permits the roll assembly to be transported from the multi-nip calender 2 to the roll store 3 and vice versa.

The roll store 3 arranged on the roll-changing apparatus 1 according to the invention is preferably designed to accommodate and to carry the moveable conveying means 15 of the lifting carriage 14 and the roll assembly located on the latter. In a preferred embodiment of the invention, the roll store has a number of horizontal carriers 31 located one above another and, between these, load-bearing racks 32 and/or load-bearing rollers 33, which are mounted on the horizontal carriers 31 and/or load-bearing racks 33. It is therefore possible for the roll assembly taken out of the multi-nip calender 2 and placed onto the conveying means 15 to be moved in a simple way from the lifting carriage 14 to the roll store 3 and vice versa.

As can further be seen from the FIGURE, the roll-changing apparatus 1 according to the invention also includes a lifting platform 4 which is provided for the maintenance personnel, which is fixed to the vertical columns 11 and moves vertically along the latter with its own control apparatus. Using this lifting platform, during machine operation, the state of the roll system of the calender 2 can be observed, and relatively small maintenance actions can be carried out.

When the roll-changing apparatus according to the invention is used, the action of changing polymer or paper rolls in a multi-nip calender, including their equipment, between calender and storage space is carried out as follows. During the operation of the calender 2, the roll-changing apparatus 1 is located in its position “A” closest to the roll system of the calender, and it is locked to the upright 23 of the calender 2. The lifting carriage 14 is locked mechanically at the top in the standby position, and the lifting platform 4 integrated into the portal upright 10 of the roll-changing apparatus 1 is available in front of the roll system of the calender 2 for maintenance and condition monitoring tasks.

During the roll change, the roll-changing apparatus 1 is moved in the horizontal direction, on rails 18 present in the floor, into the changing position “B”, with which the lifting carriage 14 can be conveyed to the roll 22 to be changed. The roll-changing apparatus 1 is then moved into the position “A”, following which the roll 22, together with the associated additional parts or equipment, can be removed as a complete roll assembly and taken out of the calender 2 on the lifting carriage 14. The equipment of the roll, such as the removal roll or guide roll, doctor, steam box and so on, is fixed to the roll 22 during the entire removal of the roll 22 from the calender 2 and its transport into the roll store 3, and they are removed only during the maintenance of the roll. The roll is therefore conveyed with the equipment, that is to say as a complete roll assembly, by the roll-changing apparatus 1:

to the roll store 3, into the position “C”, and

to an empty storage space in the roll store 3, which is, for example, the rack 32.

Then, using the roll-changing apparatus 1, a new roll 22 including equipment, that is to say as a complete roll assembly, is moved from the roll store 3 into the calender 2 and fixed in the latter. The roll-changing apparatus 1 is then moved into the position “A” again.

Corresponding to a preferred embodiment of the invention, the roll-changing apparatus 14 is equipped with a turning apparatus 143 for the roll 21, 22, with which apparatus thermal stress damage to the roll is prevented. This roll turning apparatus comprises, for example, at least one circumferential turning roll or roller 143 which comes or is brought into contact with the outer circumference of the roll 21, 22 and is rotatably mounted on the side carrier parts 141 of the lifting carriage 14 or on the rack part 142, and the power apparatus driving the said roll or roller (not shown in the FIGURE) is likewise fitted to the side carrier part 141 of the lifting carriage 14 or to the rack part 142.

In order to avoid damage to the roll 21,22, it is recommended that it be possible for the bearings to be positioned in the correct direction during the entire duration 30 of the roll change and mounting in the various positions of the roll 21,22. In order to achieve this, the lifting carriage 14 or the conveying platform 15 of the roll-changing apparatus 1 according to the invention is equipped with one or more actuating device or devices, which positions or position the bearing housings of the roll 21,22. This actuating device is, for example, fitted to the conveying platform 15, the side carrier part 141 or the rack part 142.

In order to change chill-cast rolls 21 and rolls marketed by the applicant under the trade name SYMTM, the roll-changing apparatus 1 is used to remove the chill-cast roll 21 from the machine and to insert it into the machine, the chill-cast rolls 21 being transported to the storage space by a machine-hall crane.

1. Roll-changing apparatus for a multi-nip calender, the upright part (10) of the roll-changing apparatus having at least one vertical column (11), to which at least one horizontal beam (12) and, at its lower end, a carrier part (13), that is to say an end carrier, belong, and the roll-changing apparatus (1) including a vertically moveable lifting carriage (14) which is supported on the vertical column and whose vertically moving lifting mechanism (15) is fitted to a vertical column, preferably to its upper part, characterized in that for transporting the rolls (21,22) and the associated equipment and additional devices of the calender (2) in the lateral direction from the calender to the roll store (3) and vice versa, the roll-changing apparatus (1) can be conveyed between calender and roll store, and the lifting carriage (14) of the roll-changing apparatus (1) is immovable in the lateral direction with respect to the vertical column (11).

2. Roll-changing apparatus according to claim 1, characterized in that the lifting carriage (14) moves vertically between two vertical columns (11).

3. Roll-changing apparatus according to claim 1 and/or 2, characterized in that an end support (13) at the lower end of each vertical column (11) of the roll-changing apparatus (1) is equipped with conveying elements (17) which move on guide means (18) present in the floor.

4. Roll-changing apparatus according to claim 3, characterized in that the conveying elements present on the end carriage (13) have wheels (17) which are mounted in the said elements and which run on rails (18) present in the floor of the machine hall.

5. Roll-changing apparatus according to claim 1 and/or 2, characterized in that the lifting carriage (14) includes a side carrier part (141), preferably sleeve-like, which moves along vertically on the respective vertical column (11).

6. Roll-changing apparatus according to one of the preceding claims 1 to 5, characterized in that in order to remove and reinstall the roll (21,22) and the associated equipment and additional devices of the calender (2), such as lead-in or lead-out roll, doctor, steam box and so on, to be changed and to pick up the complete roll assembly from the calender (2) or lifting carriage (14), the lifting carriage (14) includes a conveying means (15) which can move in the lateral direction on the said carriage.

7. Roll-changing apparatus according to claim 6, characterized in that the conveying means (15) comprises a conveying platform or similar support, and the lifting carriage (14) is equipped with rotatable load-bearing rollers or rolls (19) for the purpose of achieving the lateral mobility thereof.

8. Roll-changing apparatus according to claim 7, characterized in that the roll store (3) has a number of horizontal carriers (31) located one above another and, between these, carrier racks (32) and/or carrier rollers or rolls (33), which are mounted on the horizontal carriers (31) and/or the carrier racks (32).

9. Roll-changing apparatus according to claim 6, characterized in that the lifting carriage (14) is equipped with a turning apparatus for the roll (21,22) in order to prevent thermal stress damage to the roll.

10. Roll-changing apparatus according to claim 6 and/or 9, characterized in that the lifting carriage (14) or the conveying platform (15) of the roll-changing apparatus (1) is equipped with an actuating device for positioning the bearing housing or the bearing housings of the roll (21,22) in the correct position in the various positions of the roll (21,22).
